(19) United States
(12) Patent Application Publication
(10) Pub. No.: US 2009/0127384 A1
(43) Pub. Date: May 21, 2009

(54) Wake Ingestion Propulsion System for Buoyant Aircraft

(76) Inventor: Michael Todd Voorhees, Bouder, CO (US)

Correspondence Address: MICHAEL TODD VOORHEES, 2255 MARIPOSA AVENUE, BOULDER, CO, 80302, US

(21) Appl. No.: 12/116,089

(22) Filed: May 6, 2008

Related U.S. Application Data
(60) Provisional application No. 60/917,933, filed on May 15, 2007.

(51) Int. Cl. B64C 11/00

(52) U.S. Cl. 244/65

(57) ABSTRACT

A system for utilizing the slower boundary layer and aircraft wake to improve propulsive efficiency for buoyant and semi-buoyant aircraft is described. By ingesting air through an annular inlet located at the aft portion of the aircraft and accelerating it via an embedded ducted fan, maximum propulsive efficiency may be obtained, without the excessive losses due to viscous drag forces experienced in vehicles utilizing long ducts drawing air from inlets placed further forward. The method also reduces the acoustic signature when compared to unshrouded stem propellers or freestanding ducts.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to manned and unmanned airships and other buoyant and semi-buoyant vehicles, and more particularly relates to the use of a wake ingesting embedded ducted fan to provide efficient propulsion thereof.

2. Description of the Related Art

In the past few decades the vast majority of aircraft designers have focused on high performance, high speed jet aircraft, where efficiency is highly dependent upon compression of the ingested air. As such, most aircraft designers go to great lengths to avoid ingesting either the boundary layer or aircraft wake, which requires more work to compress than the higher velocity free stream air. Yet for the purposes of slower propeller driven Proprietary Information of Michael T. Voorhees aircraft, such concerns are reversed. It is understood that in cold air propulsion, propulsive efficiency is proportional to mass flow and thus sensitive to the velocity of air ingested into the propulsor. All other things being equal, the slower the velocity of ingested air, the higher the propulsive efficiency.

In aircraft design, minimization of drag is also of extreme importance. The three major categories of drag being form drag (also know as pressure drag), skin friction drag (also known as viscous drag), and induced drag. For pure aerostatic vehicles operating at level pitch, induced drag is not a factor. For most heavier-than-air designs, form drag is more dominant than skin friction, whereas in buoyant aircraft, given the large surface area, skin friction becomes dominant. Chapman, whose patent is generically directed toward fluid-borne vehicles as diverse as submarines and airships, states in the abstract “A method and arrangement for propelling fluidborne vehicles is disclosed that results in reduction in the overall form drag of certain classes of vehicles”. He also states that an object of his invention is to “reduce form drag created by the vehicle while avoiding flow separation of the afterbody of the vehicle during under-thrusted conditions.” For submarines, which travel through the much denser medium of water, form drag is of greater concern. With airships, this is less so. The inlet arrangement specified by Chapman is not surprisingly sub-optimized for airships. As Chapman claims “A propulsion system arrangement for a fluidborne vehicle comprising: a vehicle including a forebody section, an afterbody section and a transition region joining the forebody and afterbody sections, the forebody section having an outer surface with a shape diverging from the forward most point of the vehicle to and including the widest portion of the vehicle, the afterbody section having an outer surface with a shape converging inwardly in the rearward direction of the vehicle to a shape with cross-sectional area smaller than that at the transition region and having a central outlet nozzle facing rearwardly therefrom, at least a portion of the surface of the vehicle contacting a fluid medium, a single inlet for inducting fluid from the fluid medium, said inlet located solely in the transition region . . . ” In computational fluid dynamics modeling of airships with a symmetric body of revolution shape, one finds that air moving past the hull at the above described “transition region” between forebody and afterbody sections is at a higher relative velocity than even the free stream. Thus it is clear that to maximize propulsive efficiency, this is the least desirable location for an inlet. Such a location also requires unnecessarily long ducts and incurs associated efficiency losses due to boundary layer effects. Furthermore, Chapman specifies, “the afterbody section is tapered at an angle of no more than 15° with respect to the direction of motion”. Such a structure will require more hull mass per enclosed volume, and thus less disposable lift.

### BRIEF SUMMARY OF THE INVENTION

The current invention is a propulsion system for the controlled flight of buoyant and semi-buoyant aircraft. It may be used to propel a vehicle with a predominately symmetrical body of revolution hull form, optimally with a fineness ratio (length to diameter) of between 3 and 4.5. Near the far aft section of the aircraft hull, ideally where the hull taper is at an angle of 18° or greater with respect to the direction of motion in level flight, an annular inlet circumscribing the aircraft is located so as to ingest air from both the boundary layer and aircraft wake. It is by accelerating a large volume of slow moving air through the propulsor that high propulsive efficiency is achieved. This overcomes previous inventions that inefficiently ingested free stream air via outboard propellers, or ingested air at the widest portion of the airship where air even faster than freestreem is prevalent in a misguided emphasis on reducing form drag. It also overcomes deficiencies of other sub-optimal designs for stern propulsion, including less efficient and noisy unshrouded propellers, and those with poorly designed ducts. The annular inlet opens to an annular duct providing a gradual deflection into and then rearwardly through a propulsive means. Avoidance of abrupt angular surfaces is desired and the cross-sectional area of the flow should gradually constrict to a minimum as air passes through the propulsor and then gradually expand toward the outlet. The propulsive means could be any of a number of prior art technologies, such as a fixed or variable pitch fan powered by electric motor, combustion engine, or gas turbine. When used as the main propulsive component in conjunction with steering means such as aerodynamic control surfaces, vectored thrust, or differential thrust, or some combination thereof, efficient controlled aerostatic flight may be achieved.

### BRIEF DESCRIPTION OF THE SEVERAL VIEWS OF THE DRAWINGS

FIG. 1 illustrates a wake ingestion propulsion system for buoyant aircraft of the present invention. Like numerals identify identical items throughout the figures.

FIG. 1a shows the external view of the buoyant aircraft 1 as seen from the starboard side with the bow to the right and stem to the left. The annular inlet 2 and annular outlet 3 partially define the location and form of the annular duct 7. The forwardmost wall of the duct 4 is partially visible in this view.

FIG. 1b shows the system from the same viewpoint, but in cross section, whereby the buoyant aircraft 1 and components have been sectioned lengthwise in half, revealing the relative position and form of the annular duct 7 as defined by the forwardmost wall of the duct 4 and the outer wall of the duct 5, as well as the location of the propulsive means 6 as it operates within the duct.

FIG. 2 shows a close-up of the cross sectional view in FIG. 1b with a schematic representation of airflow indicating layers of circumferential rearward flow, with the layer closest to the hull or boundary layer labeled A, an intermediate layer characteristic of the aircraft wake labeled B, and a more outward layer of freestream air labeled C.

### DETAILED DESCRIPTION OF THE INVENTION

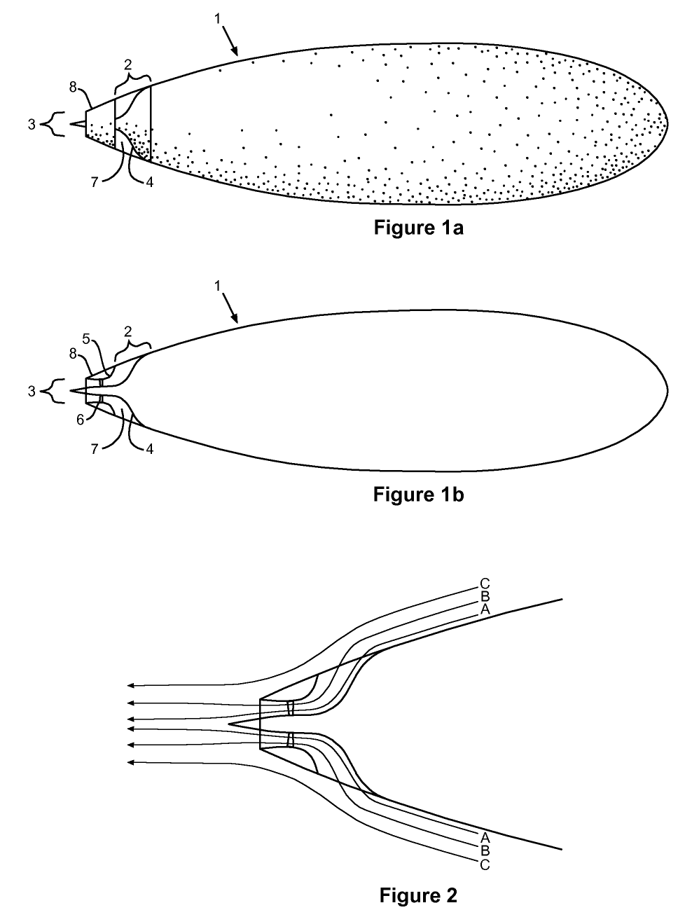

Referencing FIGS. 1a, 1b and 2, this invention is a propulsion system for the controlled flight of buoyant and semi-buoyant aircraft comprising a buoyant aircraft 1, with a predominately symmetrical body of revolution hull form, upon which an annular inlet 2 circumscribing the far aft section of the aircraft hull is located, ideally where the hull taper is at an angle of 18° or greater with respect to the direction of motion in level flight, so as to ingest slowest air from the boundary layer A and slow air from the aircraft wake B, avoiding ingestion of the fast freestream air C. The air, thus ingested, flows through an annular duct 7 bounded in the middle by the forwardmost wall of the duct 4, beginning at the forward lip of the inlet and tapering inwardly and then rearwardly to meet with the hub of the propulsive means 6, and continuing aft to a tapered point. The annular duct 7 is bounded circumferentially by the outer wall of the duct 5, beginning where its leading edge forms the aft lip of the annular inlet 2. Together, the outer wall of the duct 5 with the aft annular hull section 8 forms an annulus with a cross section somewhat resembling an airfoil. The annular duct 7 provides a path for ingested air with a gradual deflection contractingly into and then rearwardly through a propulsive means 6, whereupon the energized air exits expansively toward and out of the annular outlet 3. It should be noted that the propulsive means 6, consisting of prior art such as a fixed or variable pitch fan system, is located at the most areally constricted portion of the annular duct.

In the above manner, air of the slowest available velocity, located adjacent to the aft portion of the hull, is accelerated, maximizing the propulsive efficiency of the buoyant aircraft, while higher velocity air is allowed to bypass the propulsor. Furthermore, since the propulsive means 6, is located within the annular duct 7, blade tip flow reversal during static conditions is eliminated and a minimal acoustic signature is achieved.

What I claim as my invention is:

1. A propulsion system for the controlled flight of buoyant and semi-buoyant aircraft comprising:
a vehicle with a predominately symmetrical body of revolution hull form;
an annular inlet circumscribing the far aft section of the aircraft hull located so as to ingest air from the boundary layer and slower aircraft wake;
an annular duct providing a gradual deflection into and then rearwardly through a propulsive means, the forwardmost wall of the duct beginning at the forward lip of the inlet and tapering inwardly and then rearwardly to meet with the hub of the propulsive means and continuing aft to a tapered point, the aft lip of the inlet at the leading edge of the outer wall of the duct together with the hull at this section forming an annulus, and the flow capacity of the duct contracting from the inlet to the propulsive means, and then expanding to an annular outlet;
propulsive means such as a fixed or variable pitch fan system located at the most areally constricted portion of the annular duct;
an annular outlet at the very aft section of the aircraft surrounding the tapered extension of the hub from the propulsor.

2. A propulsion system of claim 1 whereby the propulsive means is powered by electric motor.

3. A propulsion system of claim 1 whereby the propulsive means is powered by internal combustion engine.

4. A propulsion system of claim 1 whereby the propulsive means is powered by gas turbine.

5. A propulsion system of claim 1 used in conjunction with conventional aerodynamic control surfaces to provide stability and maneuver in flight.

6. A propulsion system of claim 1 used in conjunction with a vectorable thrust system to provide stability and maneuver in flight.

7. A propulsion system of claim 1 used in conjunction with a differential thrust system to provide stability and maneuver in flight.
